(19) United States
(12) Patent Application Publication
(10) Pub. No.: US 2015/0139122 A1
(43) Pub. Date: May 21, 2015

(54) SHARED NON-LINEAR INTERFERENCE CANCELLATION MODULE FOR MULTIPLE RADIOS COEXISTENCE AND METHODS FOR USING THE SAME

(71) Applicant: QUALCOMM INCORPORATED, San Diego, CA (US)

(72) Inventors: Roberto RIMINI, San Diego, CA (US); Jibing WANG, San Diego, CA (US)

(21) Appl. No.: 14/526,814

(22) Filed: Oct. 29, 2014

Related U.S. Application Data
(60) Provisional application No. 61/907,171, filed on Nov. 21, 2013.

(51) Int. Cl. H04L 5/00; H04W 72/08

(52) U.S. Cl. CPC H04L 5/0062; H04W 72/082; H04W 88/06
USPC 370/329

(57) ABSTRACT

Certain aspects of the present methods and apparatus provide a scheme to implement a generic Non-Linear Interference Cancelation (NLIC) module that can be interfaced with any topology of aggressor-victim transmitters and/or receivers of any (e.g., one or more) radio-access technology residing on the same communication device.

### CLAIM OF PRIORITY UNDER 35 U.S.C. §119

This application claims benefit of U.S. Provisional Patent Application Ser. No. 61/907,171, filed Nov. 21, 2013 and entitled “Shared Non-Linear Interference Cancellation Module for Multiple Radios Coexistence”, incorporated by reference in its entirety.

### TECHNICAL FIELD

Certain aspects of the present disclosure generally relate to wireless communications and, more particularly, to a shared non-linear interference cancellation module (e.g., a self-contained module) for multiple radios coexistence and methods for using the same.

### BACKGROUND

Wireless communication systems are widely deployed to provide various types of communication content such as voice, data, and so on. These systems may be multiple-access systems capable of supporting communication with multiple users by sharing the available system resources (e.g., bandwidth and transmit power). Examples of such multiple-access systems include code division multiple access (CDMA) systems, time division multiple access (TDMA) systems, frequency division multiple access (FDMA) systems, 3GPP Long Term Evolution (LTE) systems, and orthogonal frequency division multiple access (OFDMA) systems.

Generally, a wireless multiple-access communication system can simultaneously support communication for multiple wireless terminals. Each terminal communicates with one or more base stations via transmissions on the forward and reverse links. The forward link (or downlink) refers to the communication link from the base stations to the terminals, and the reverse link (or uplink) refers to the communication link from the terminals to the base stations. This communication link may be established via a single-in-single-out, multiple-in-single-out or a multiple-in-multiple-out (MIMO) system.

A MIMO system employs multiple (N_{T}) transmit antennas and multiple (N_{R}) receive antennas for data transmission. A MIMO channel formed by the N_{T} transmit and N_{R} receive antennas may be decomposed into N_{S} independent channels, which are also referred to as spatial channels, where N_{S}≦min{N_{T}, N_{R}}. Each of the N_{S} independent channels corresponds to a dimension. The MIMO system can provide improved performance (e.g., higher throughput and/or greater reliability) if the additional dimensionalities created by the multiple transmit and receive antennas are utilized.

A MIMO system may support time division duplex (TDD) and/or frequency division duplex (FDD) systems. In a TDD system, the forward and reverse link transmissions are on the same frequency region so that the reciprocity principle allows the estimation of the forward link channel from the reverse link channel. This enables the base station to extract transmit beamforming gain on the forward link when multiple antennas are available at the base station. In an FDD system, forward and reverse link transmissions are on different frequency regions.

Ever growing demand for high data rate fueled by the proliferation of applications requires a wireless device to support multiple radio access technologies (RATs), which may involve multiple radios. In some cases, coexistence of multiple radios in the same multimode transceiver may be problematic due to unavoidable cross-interference scenarios that negatively impact the performance of a victim receiver.

### SUMMARY

Certain aspects of the present disclosure provide a method for wireless communications. The method generally includes configuring a shared non-linear interference cancellation (NLIC) module, in a first operating mode involving a first transmitter-receiver pair of a plurality of transmitter-receiver pairings, to cancel self-jamming interference caused by signals transmitted by a first transmitter on a first aggressor frequency band interfering with signals received by a first receiver on a first victim frequency band, and configuring the shared NLIC module, in a second operating mode involving a second transmitter-receiver pair, to cancel self-jamming interference caused by signals transmitted by a second transmitter on a second aggressor frequency band interfering with signals received by a second receiver on a second victim frequency band.

Certain aspects of the present disclosure provide an apparatus for wireless communications. The apparatus generally includes a plurality of transmitter-receiver pairs, and a shared non-linear interference cancellation (NLIC) module configurable, in different operating modes of the apparatus involving different transmitter-receiver pairs, to cancel self-jamming interference caused by one or more signals transmitted by one or more transmitters on one or more aggressor frequency bands interfering with one or more signals received by one or more receivers on one or more victim frequency bands.

Certain aspects of the present disclosure provide an apparatus for wireless communications. The apparatus generally includes means for configuring a shared non-linear interference cancellation (NLIC) module, in a first operating mode involving a first transmitter-receiver pair, to cancel self-jamming interference caused by signals transmitted by a first transmitter on a first aggressor frequency band interfering with signals received by a first receiver on a first victim frequency band, and means for configuring the shared NLIC module, in a second operating mode involving a second transmitter-receiver pair, to cancel self-jamming interference caused by signals transmitted by a second transmitter on a second aggressor frequency band interfering with signals received by a second receiver on a second victim frequency band.

Certain aspects of the present disclosure provide a computer-readable medium having instructions executable by a computer stored thereon. The instructions are generally capable for configuring a shared non-linear interference cancellation (NLIC) module, in a first operating mode involving a first transmitter-receiver pair, to cancel self-jamming interference caused by signals transmitted by a first transmitter on a first aggressor frequency band interfering with signals received by a first receiver on a first victim frequency band, and configuring the shared NLIC module, in a second operating mode involving a second transmitter-receiver pair, to cancel self-jamming interference caused by signals transmitted by a second transmitter on a second aggressor frequency band interfering with signals received by a second receiver on a second victim frequency band.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates a multiple access wireless communication system, in accordance with certain aspects of the present disclosure.

FIG. 2 illustrates a block diagram of a communication system, in accordance with certain aspects of the present disclosure.

FIG. 3 illustrates an example block diagram of a shared (e.g., self-contained) Non-Linear Interference Cancellation (NLIC) module interfaced with two transceivers within a common wireless communication device, in accordance with certain aspects of the present disclosure.

FIG. 4 illustrates an example block diagram of a shared (e.g., self-contained) NLIC module interfaced with three transceivers within a common wireless communication device, in accordance with certain aspects of the present disclosure.

FIG. 5 illustrates example operations for configuring a shared (e.g., self-contained) NLIC module to cancel self-jamming interference, in accordance with certain aspects of the present disclosure.

FIG. 5A illustrates example means capable of performing the operations shown in FIG. 5, in accordance with certain aspects of the present disclosure.

### DETAILED DESCRIPTION

Aspects of the present disclosure provide methods and apparatus that may be utilized to implement a generic (e.g., shared and self-contained) Non-Linear Interference Cancellation (NLIC) module. Such a NLIC module may be interfaced with a wide variety of different topologies of aggressor(s)-victim(s) of any wireless radio access technology (RAT). Such a NLIC module may operate by taking as an input an aggressor-transmitted baseband signal, as well as an observed corrupted baseband signal at a victim receiver.

In a transceiver (e.g., a frequency division duplex (FDD) transceiver), an interference (e.g., the strongest interference) associated with a received signal may be caused by self-jamming leakage from a transmission signal that is, for example, simultaneously or nearly simultaneously transmitted by the transceiver. For example, the transmission signal may leak into a receive path through a finite isolation (e.g., through a duplexer filter, antenna coupling, circuit card electromagnetic interference (EMI) also referred as an on-board coupling, Very-Large-Scale Integration (VLSI) chip coupling, and alike). Although being in a different frequency band, the transmission leakage signal may cause co-channel interference on the intended received signal due to excitations of some non-linear behavior in an aggressor radio frequency (RF) transmitter chain. This scenario is referred to herein as self-jamming interference. The co-channel self-jamming interference may additionally or alternatively be generated at a victim receiver when nonlinearities are excited in RF down-conversion components, such as low noise amplifiers (LNAs), mixers, switches, filters, data converters and other like components.

The proliferation of radios in the same wireless communication device required to support multiple simultaneous applications opens new challenges related to the cross-interference among different transceivers. The non-linear behavior of analog RF chains of a transceiver may be a dominant cause of the cross-interference mechanism through generation of undesired energy in proximity of a victim receiver frequency. Each aggressor-victim pair may have its own specific non-linear mechanism of cross-jamming that can be mitigated when, for example, a Non-Linear Interference Cancellation (NLIC) unit is placed at the victim receiver modem.

Given that the numbers of radios co-located within the same wireless communication device is rapidly growing, placing a NLIC unit or module inside each of a baseband (receive) modem would not be efficient in terms of area/cost/design and testing time. Hence, a shared NLIC unit or module (e.g., “self-contained module”) residing in a dedicated location in the wireless communication device that may be interfaced with any pair of aggressor-victim at a given time, as proposed herein, may be of benefit.

Various aspects are now described with reference to the drawings. In the following description, for purposes of explanation, numerous specific details are set forth in order to provide a thorough understanding of one or more aspects. It may be evident, however, that such aspect(s) may be practiced without these specific details.

As used in this application, the terms “component,” “module,” “system” and the like are intended to include a computer-related entity, such as but not limited to hardware, firmware, a combination of hardware and software, software, or software in execution. For example, a component may be, but is not limited to being, a process running on a processor, a processor, an object, an executable, a thread of execution, a program and/or a computer. By way of illustration, both an application running on a computing device and the computing device can be a component. One or more components can reside within a process and/or thread of execution and a component may be localized on one computer and/or distributed between two or more computers. In addition, these components can execute from various computer readable media having various data structures stored thereon. The components may communicate by way of local and/or remote processes such as in accordance with a signal having one or more data packets, such as data from one component interacting with another component in a local system, distributed system, and/or across a network such as the Internet with other systems by way of the signal.

Furthermore, various aspects are described herein in connection with a terminal, which can be a wired terminal or a wireless terminal. A terminal can also be called a system, device, subscriber unit, subscriber station, mobile station, mobile, mobile device, remote station, remote terminal, access terminal, user terminal, communication device, user agent, user device, or user equipment (UE). A wireless terminal may be a cellular telephone, a satellite phone, a cordless telephone, a Session Initiation Protocol (SIP) phone, a wireless local loop (WLL) station, a personal digital assistant (PDA), a handheld device having wireless connection capability, a computing device, or other processing devices connected to a wireless modem. Moreover, various aspects are described herein in connection with a base station. A base station may be utilized for communicating with wireless terminal(s) and may also be referred to as an access point, a Node B, an eNode B, or some other terminology.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

The techniques described herein may be used for various wireless communication networks such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. The terms “networks” and “systems” are often used interchangeably. A CDMA network may implement a radio technology such as Universal Terrestrial Radio Access (UTRA), CDMA 2000, etc. UTRA includes Wideband-CDMA (W-CDMA). CDMA2000 covers IS-2000, IS-95 and IS-856 standards. A TDMA network may implement a radio technology such as Global System for Mobile Communications (GSM).

An OFDMA network may implement a radio technology such as Evolved UTRA (E-UTRA), The Institute of Electrical and Electronics Engineers (IEEE) 802.11, IEEE 802.16, IEEE 802.20, Flash-OFDM®, etc. UTRA, E-UTRA, and GSM are part of Universal Mobile Telecommunication System (UMTS). Long Term Evolution (LTE) is a recent release of UMTS that uses E-UTRA. UTRA, E-UTRA, GSM, UMTS and LTE are described in documents from an organization named “3rd Generation Partnership Project” (3GPP). CDMA2000 is described in documents from an organization named “3rd Generation Partnership Project 2” (3GPP2). These various radio technologies and standards are known in the art. For clarity, certain aspects of the techniques are described below for LTE, and LTE terminology is used in much of the description below. It should be noted that the LTE terminology is used by way of illustration and the scope of the disclosure is not limited to LTE. Rather, the techniques described herein may be utilized in various applications involving wireless transmissions, such as personal area networks (PANs), body area networks (BANs), location, Bluetooth, GPS, UWB, RFID, and the like. Further, the techniques may also be utilized in wired systems, such as cable modems, fiber-based systems, and the like.

Single carrier frequency division multiple access (SC-FDMA), which utilizes single carrier modulation and frequency domain equalization has similar performance and essentially the same overall complexity as those of an OFDMA system. SC-FDMA signal may have lower peak-to-average power ratio (PAPR) because of its inherent single carrier structure. SC-FDMA may be used in the uplink communications where lower PAPR greatly benefits the mobile terminal in terms of transmit power efficiency. SC-FDMA is currently a working assumption for uplink multiple access scheme in 3GPP Long Term Evolution (LTE), or Evolved UTRA.

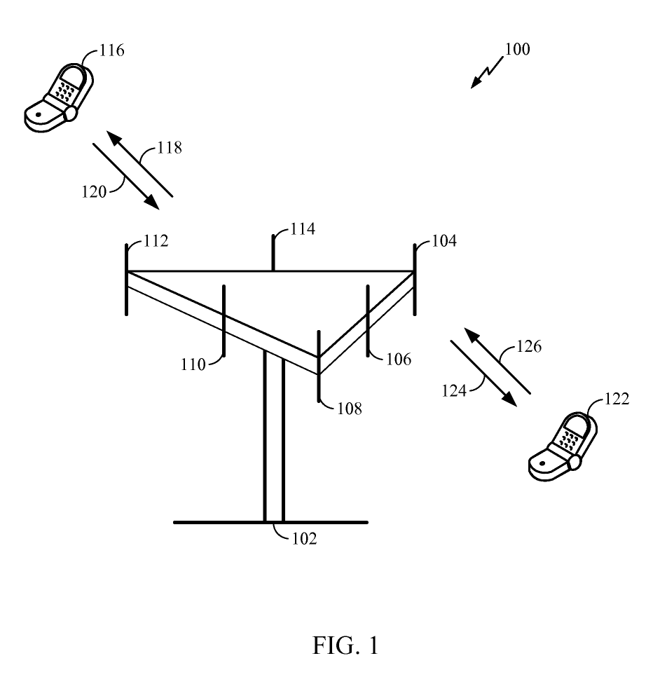

Referring to FIG. 1, a multiple access wireless communication system 100 according to one aspect is illustrated, in which aspects of the present disclosure may be practiced. For example, an access point (AP) 102 and/or an access terminal (AT) (e.g., AT 116, AT 122 from FIG. 1) may comprise a plurality of transmitter-receiver pairs and may utilize an NLIC module as described herein to cancel interference (e.g., self-jamming interference).

The AP 102 includes multiple antenna groups, one including 104 and 106, another including 108 and 110, and an additional including 112 and 114. In FIG. 1, only two antennas are shown for each antenna group, however, more or fewer antennas may be utilized for each antenna group. The access terminal 116 is in communication with antennas 112 and 114, where antennas 112 and 114 transmit information to access terminal 116 over forward link 118 and receive information from access terminal 116 over reverse link 120. The access terminal 122 is in communication with antennas 104 and 106, where antennas 104 and 106 transmit information to access terminal 122 over forward link 124 and receive information from access terminal 122 over reverse link 126. In a Frequency Division Duplex (FDD) system, communication links 118, 120, 124 and 126 may use a different frequency for communication. For example, forward link 118 may use a different frequency than that used by reverse link 120.

Each group of antennas and/or the area in which they are designed to communicate is often referred to as a sector of the access point. In an aspect, antenna groups each are designed to communicate to access terminals in a sector of the areas covered by access point 102.

In communication over forward links 118 and 124, the transmitting antennas of access point 102 utilize beamforming in order to improve the signal-to-noise ratio of forward links for the different access terminals 116 and 122. Also, an access point using beamforming to transmit to access terminals scattered randomly through its coverage causes less interference to access terminals in neighboring cells than an access point transmitting through a single antenna to all its access terminals.

An access point may be a fixed station used for communicating with the terminals and may also be referred to as a Node B, an evolved Node B (eNB), or some other terminology. An access terminal may also be called a mobile station, user equipment (UE), a wireless communication device, terminal, or some other terminology. For certain aspects, either the AP 102 or the access terminals 116, 122 may utilize an interference cancellation technique as described herein to improve performance of the system.

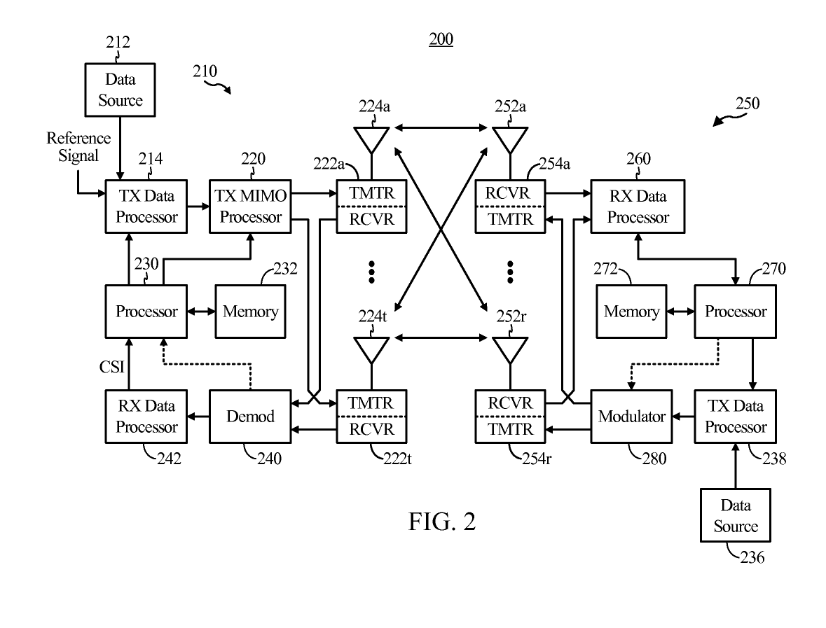

Referring to FIG. 2, a block diagram of an aspect of a transmitter system 210 (for example an AP) and a receiver system 250 (for example an AT) in a MIMO system 200 is illustrated, in which aspects of the present disclosure may be practiced. At the transmitter system 210, traffic data for a number of data streams is provided from a data source 212 to a transmit (TX) data processor 214. An aspect of the present disclosure is also applicable to a wire-line (wired) equivalent system of FIG. 2

In an aspect, each data stream is transmitted over a respective transmit antenna. TX data processor 214 formats, codes, and interleaves the traffic data for each data stream based on a particular coding scheme selected for that data stream to provide coded data.

The coded data for each data stream may be multiplexed with pilot data using OFDM techniques. The pilot data is typically a known data pattern that is processed in a known manner and may be used at the receiver system to estimate the channel response. The multiplexed pilot and coded data for each data stream is then modulated (e.g., symbol mapped) based on a particular modulation scheme (e.g., Binary Phase Shift Keying (BPSK), Quadrature Phase Shift Keying (QPSK), M-PSK in which M may be a power of two, or M-QAM (Quadrature Amplitude Modulation)) selected for that data stream to provide modulation symbols. The data rate, coding and modulation for each data stream may be determined by instructions performed by processor 230 that may be coupled with a memory 232.

The modulation symbols for all data streams are then provided to a TX MIMO processor 220, which may further process the modulation symbols (e.g., for OFDM). TX MIMO processor 220 then provides N_{T} modulation symbol streams to N_{T} transmitters (TMTR) 222a through 222t. In certain aspects, TX MIMO processor 220 applies beamforming weights to the symbols of the data streams and to the antenna from which the symbol is being transmitted.

Each transmitter 222 receives and processes a respective symbol stream to provide one or more analog signals, and further conditions (e.g., amplifies, filters, and upconverts) the analog signals to provide a modulated signal suitable for transmission over the MIMO channel. N_{T} modulated signals from transmitters 222a through 222t are then transmitted from N_{T} antennas 224a through 224t, respectively.

At receiver system 250, the transmitted modulated signals are received by N_{R} antennas 252a through 252r and the received signal from each antenna 252 is provided to a respective receiver (RCVR) 254a through 254r. Each receiver 254 conditions (e.g., filters, amplifies, and downconverts) a respective received signal, digitizes the conditioned signal to provide samples, and further processes the samples to provide a corresponding “received” symbol stream.

An RX data processor 260 then receives and processes the N_{R} received symbol streams from N_{R} receivers 254 based on a particular receiver processing technique to provide N_{T} “detected” symbol streams. The RX data processor 260 then demodulates, deinterleaves and decodes each detected symbol stream to recover the traffic data for the data stream. The processing by RX data processor 260 is complementary to that performed by TX MIMO processor 220 and TX data processor 214 at transmitter system 210. As described in further detail below, the RX data processor 260 may utilize interference cancellation to cancel the interference on the received signal.

Processor 270, coupled to a memory 272, formulates a reverse link message. The reverse link message may comprise various types of information regarding the communication link and/or the received data stream. The reverse link message is then processed by a TX data processor 238, which also receives traffic data for a number of data streams from a data source 236, modulated by a modulator 280, conditioned by transmitters 254a through 254r, and transmitted back to transmitter system 210.

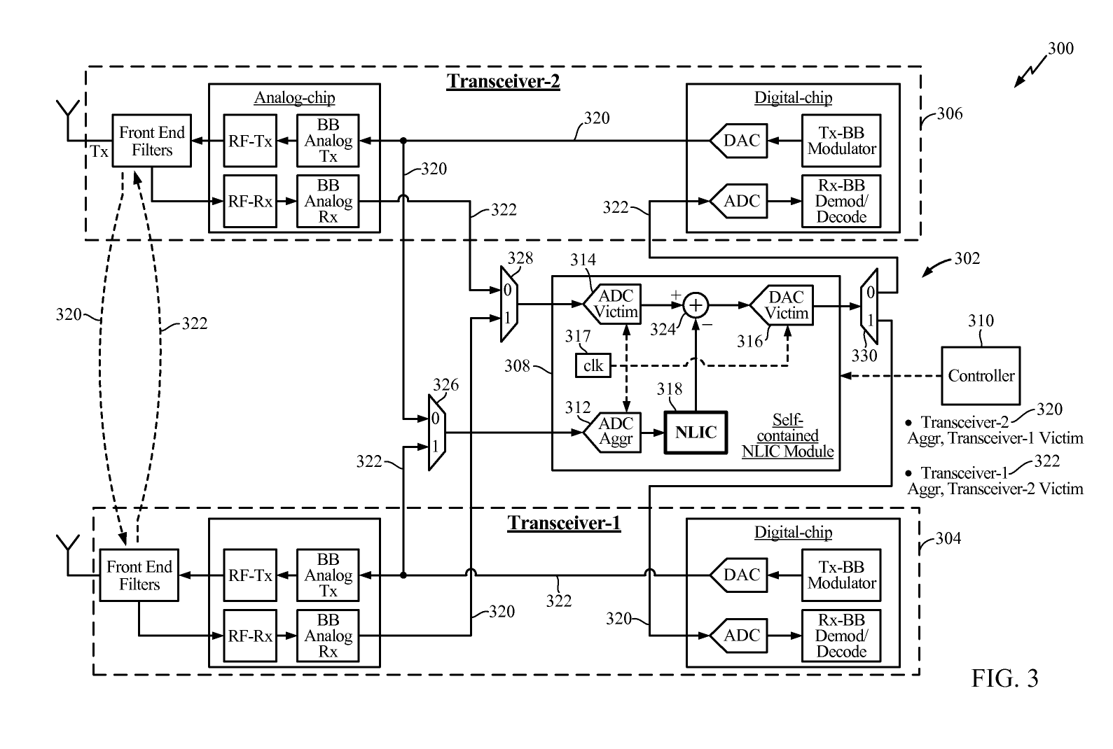

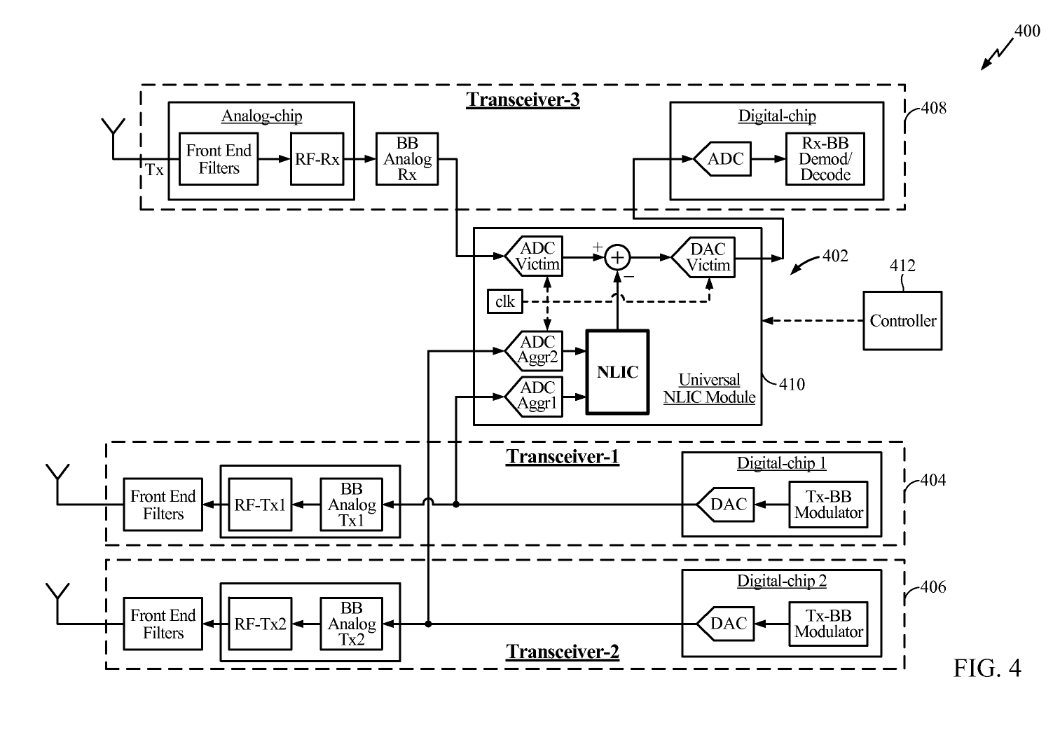

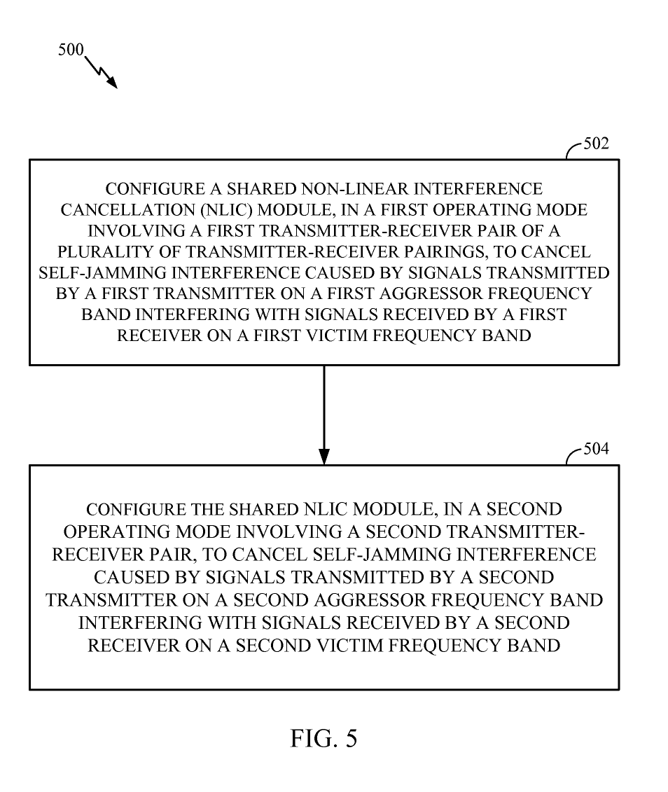

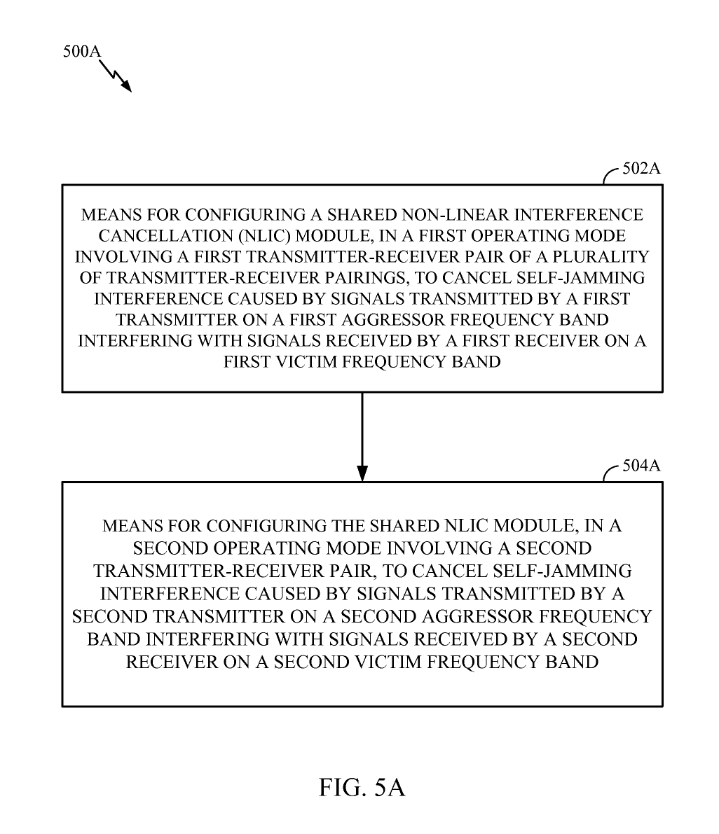

At transmitter system 210, the modulated signals from receiver system 250 are received by antennas 224, conditioned by receivers 222, demodulated by a demodulator 240 and processed by a RX data processor 242 to extract the reserve link message transmitted by the receiver system 250. According to certain aspects of the present disclosure, the transmitter system 210 and/or the receiver system 250 may comprise one or more components of block diagrams 300 and/or 400 described below and illustrated in FIGS. 3-4. According to certain aspect of the present disclosure, the controller/processor 230, the transceivers 222 and/or other processors and modules at the transmitter system 210 may perform or direct operations 500 in FIG. 5 and/or other processes for the techniques described herein. According to certain aspect of the present disclosure, the controller/processor 270, the transceivers 254 and/or other processors and modules at the receiver system 250 may perform or direct operations 500 in FIG. 5 and/or other processes for the techniques described herein. However, any component and/or processor in FIG. 2 may perform the processes for the techniques described herein.

Certain aspects of the present disclosure propose a method of implementing a generic (e.g., cross-chips) Non-Linear Interference Cancellation (NLIC) module that can be interfaced with any topology of aggressor(s)-victim(s) (e.g., on one or more chips) of any technology (e.g., one or more technologies), such as: Wide Area Network (WAN), Wireless Local Area Network (WLAN), Global Positioning System (GPS), Bluetooth, and so on. According to certain aspects of the present disclosure, the presented generic NLIC module may be implemented within the transmitter system 210 and/or the receiver system 250 from FIG. 2, e.g., as a part of the transmitter/receiver (transceiver) 222 and/or the transmitter/receiver (transceiver) 254. According to certain aspects of the present disclosure, the controller/processor 230 of the transmitter system 210 may be configured to perform operations of the generic NLIC module. According to certain aspects of the present disclosure, the controller/processor 270 of the receiver system 250 may be configured to perform operations of the generic NLIC module.

For the NLIC module to operate, the aggressor-transmitted baseband signal may need to be provided as its input and the observed corrupted baseband signal may need to be present at the victim receiver. In an aspect of the present disclosure, the NLIC module may comprise a plurality of analog-to-digital converters (ADCs) or similar logic, e.g., aggressor and victim ADCs, configured to sense the aggressor transmission signals and the corrupted victim signals, respectively. The NLIC module may further utilize a digital-to-analog converter (DAC) or similar logic at its output (e.g., a victim-DAC) configured to deliver the signal without interference (e.g., “cleaned signal”) to the victim receiver modem after the interference mitigation/cancellation.

In accordance with certain aspects of the present disclosure, the interference reconstruction may be implemented within the NLIC module or unit wherein the interference mitigation/cancellation algorithm may adaptively reconstruct the non-linear distortion as observed at the victim receiver and subtract it from the corrupted composite received signal thus generating a signal without interference (e.g., “cleaned signal”) for the victim receiver. In an aspect of the present disclosure, a controller entity, located within the NLIC module, may configure an NLIC unit (e.g., designed as a part of the NLIC module) with an appropriate non-linear mechanism or algorithm responsible for mitigating (e.g., cancelling) the cross jamming or self-jamming effect under consideration, such as: harmonics, Inter-Modulation 2^{nd} order (IM2), Inter-Modulation 3^{rd} order (IM3), Adjacent Channel Leakage Ratio (ACLR), and/or the like. This information about the cross jamming effect being mitigated (e.g., cancelled) may be determined, for example, by exploiting a priori knowledge of one or more transmitters (e.g., aggressors) and/or receiver (e.g., victim) frequencies. Additionally or alternatively, the controller entity located within the NLIC module may configure a sampling clock rate of the ADCs and/or DAC of the NLIC module based on one or more bandwidths associated with the aggressor and/or victim signals. This information can be readily available for each specific technology, such as: WAN, WLAN, GPS, etc.

By utilizing a single, “self-contained” NLIC solution (e.g., a single, “self-contained” NLIC module) shared across different chips/technologies, significant area/cost savings may be achieved. In addition, given that the algorithm for the adaptive interference estimation and reconstruction is the same for all these cases, the design and testing time can be amortized across the different chips/technologies.

### Shared Non-Linear Interference Cancellation Module for Multiple Radios Coexistence

As noted above, aspects of the present disclosure relate to mitigating (e.g., cancelling) the cross jamming interference that refers, as discussed above, to the mechanism by which a transmitted signal from a given technology (aggressor) interferes with a received signal of another co-located device (victim), for example, of a different technology. Cross-interference effects may arise due to nonlinearities of analog components of radio frequency (RF) chains of the aggressor transmitter or the victim receiver. An example of cross-interference due to the 3^{rd} harmonic of a power amplifier (PA) located in the aggressor transmitter RF chain occurs when Long-Term Evolution (LTE) transceiver (aggressor) transmits at 1880 MHz and WLAN transceiver (victim) is tuned for reception at 5640 MHz (3×1880 MHz).

An NLIC filtering algorithm may represent an effective way to combat/mitigate (e.g., cancel) cross-interference between two specific radio devices (e.g., associated with different technologies) resulting from non-linear behavior of analog components of the radios. Such a module (e.g., processor) configured for NLIC filtering may reside at a victim receiver and, hence, may benefit that given victim radio.

However, given the high number of radios present in a multimode transceiver there is a need to provide a single and versatile module for interference mitigation (e.g., cancellation) capable of interfacing with any aggressor/victim radio (e.g., with radio associated with any wireless communication technology) such that it can be shared across the different technologies/chips in a seamless way.

There are several advantages of a shared multi-standard solution for interference mitigation presented in this disclosure. First, a single design may be reused/shared across different radio technologies on an as needed basis. Second, area/cost savings may be achieved compared to a dedicated scheme per each aggressor-victim pair. Third, local ADCs within a shared NLIC module may be used to digitize aggressor and victim analog signals using a common reference clock signal. The scheme presented in this disclosure may solve the problem of timing synchronization when, for example, the aggressor and victim transceivers use independent crystal oscillators (XOs).

In the present disclosure, a shared (e.g., self-contained) NLIC module is presented that is inherently technology agnostic and hence can be linked to any aggressor-victim pair of any wireless technology within the same wireless communication device.

FIG. 3 illustrates an example block diagram 300 of a wireless communication device comprising a “self-contained” shared NLIC module 302, in accordance with certain aspects of the present disclosure. As illustrated in the example block diagram 300, the NLIC module 302 may be interfaced with a pair of transceivers 304 and 306 within the common wireless communication device. In accordance with certain aspects of the present disclosure, the wireless communication device 300 illustrated in FIG. 3 may correspond to an access point 102 and/or to access terminals 116, 122 from FIG. 1. Further, the transceivers 304, 306 and the shared NLIC module 302 may be part of the transmitter system 210 from FIG. 2 and/or the receiver system 250 from FIG. 2. According to certain aspects of the present disclosure, the processor 230 of the transmitter system 210 may be configured to perform operations of the shared NLIC module 302. According to certain aspects of the present disclosure, the processor 270 of the receiver system 250 may be configured to perform operations of the shared NLIC module 302.

In an aspect of the present disclosure, as illustrated in FIG. 3, the “self-contained” NLIC module 302 may comprise a programmable NLIC hardware unit 308 and a controller entity 310. As illustrated in FIG. 3, the NLIC hardware unit 308 may comprise an aggressor ADC 312 configured to sense a transmitted baseband signal of any aggressor chip, a victim ADC 314 configured to sense a corrupted signal (e.g., a composite signal) at baseband of any victim, a victim DAC 316 configured to transform a signal post-interference cancellation into analog domain and to interface with any victim baseband chip, a common reference clock 317 configured to operate the aforementioned ADCs and DACs, and an NLIC adaptive filter 318 configured for interference estimation and reconstruction. In an aspect, the controller 310 may be configured to program the NLIC hardware unit 308 according to a specific non-linear mechanism responsible for an observed cross jamming interference such as: Inter-Modulation 2^{nd} order (IM2), 2^{nd} harmonic (H2), 3^{rd} harmonic (H3), inter-modulation distortion (IMD), etc. In an aspect, the cross jamming mechanism may be a function of the aggressor transmission frequency and the victim receiving frequency, and therefore may be known, for example, by the RF software used by the controller 310. In addition, the controller 310 may be configured to program an appropriate sampling rate for the ADCs based on the aggressor and victim signal bandwidth also known a-priori.

According to aspects of the present disclosure, signal paths 320 in FIG. 3 may define a first scenario (e.g., a first operating mode of the wireless communication device 300) where the transceiver 306 is an aggressor and the transceiver 304 is a victim. Similarly, signal paths 322 in FIG. 3 may define a second scenario (e.g., a second operating mode of the wireless communication device 300) where the transceiver 304 is an aggressor and the transceiver 306 is a victim.

FIG. 4 illustrates an example block diagram of a wireless communication device 400 comprising a shared (e.g., “self-contained”) NLIC module 402 interfaced with three transceivers 404, 406, 408, in accordance with certain aspects of the present disclosure. As illustrated in FIG. 4, the NLIC module 402 interfaced with the transceivers 404-408 may be located within the common wireless communication device 400.

According to certain aspects of the present disclosure, the wireless communication device 400 illustrated in FIG. 4 may correspond to an access point 102 and/or to access terminals 116, 122 from FIG. 1. As noted above, according to certain aspects of the present disclosure, the transceivers 404, 406, 408 and the shared NLIC module 402 may be part of the transmitter system 210 from FIG. 2 and/or the receiver system 250 from FIG. 2.

FIG. 4 illustrates an exemplary aspect where the transceivers 404 and 406 may be configured as aggressors and the transceiver 408 may be configured as a victim. The certain configurations (operating modes) shown in FIG. 4 are only examples of the types of configurations, in accordance with aspects of the present disclosure. As illustrated in FIG. 4, the shared (e.g., “self-contained”) NLIC module 402 may comprise a programmable NLIC hardware unit 410 and a controller entity 412, having same functions as the NLIC hardware unit 308 and the controller 310 respectively, illustrated in FIG. 3 as parts of the NLIC module 302.

As described herein, a shared (e.g., “self-contained”) NLIC scheme may be capable of mitigating (e.g., cancelling) non-linear cross jamming interference for any pair of aggressor/victim chip within the same multi-radio device. As illustrated in FIG. 3, through simple multiplexer/de-multiplexer blocks programming, the NLIC module may be connected (interfaced) to any aggressor-victim pair. According to certain aspects of the present disclosure, a similar multiplexer/de-multiplexer logic and programming thereof may be employed to configure the NLIC module 402 to operate in a mode where the transceiver 404 may be the victim and one or more of the transceiver 406 and 408 serve as the aggressor. According to certain aspects of the present disclosure, the controller unit 412 may configure the NLIC hardware unit 410 with a specific non-linear interference cancellation model (e.g., algorithm) needed. In an aspect, the NLIC hardware unit 410 may be configured to adaptively reconstruct and cancel the interference (e.g., the cross jamming interference) observed at the victim receiver.

The interference mitigation (e.g., cancellation) configuration presented in this disclosure allows for flexible design. For example, in some cases, the same (hardware) design may fit different types of interference mitigation (e.g., cancellation) schemes. Area/cost savings may be achieved by sharing the same hardware across different wireless communication technologies. For example, the presented solution solves the problem of interfacing wireless communication technologies like WAN, Wi-Fi, GPS that inherently use different clock signals with different natural oscillator frequencies.

FIG. 5 illustrates example operations 500 for configuring a “self-contained” shared NLIC module (e.g., the NLIC module 302 from FIG. 3, the NLIC module 402 from FIG. 4) within a wireless communication device configured for cancelling self-jamming interference, in accordance with certain aspects of the present disclosure.

The operations 500 begin, at 502, by a shared non-linear interference cancellation (NLIC) module configured, in a first operating mode involving a first transmitter-receiver pair of a plurality of transmitter-receiver pairings of the wireless communication device, to cancel self-jamming interference caused by signals transmitted by a first transmitter on a first aggressor frequency band interfering with signals received by a first receiver on a first victim frequency band. At 504, the shared NLIC module may be configured, in a second operating mode involving a second transmitter-receiver pair of the wireless communication device, to cancel self-jamming interference caused by signals transmitted by a second transmitter on a second aggressor frequency band interfering with signals received by a second receiver on a second victim frequency band.

In an aspect of the present disclosure, a signal may be transmitted, via the first transmitter (e.g., a transmitter of the transceiver 304 in FIG. 3), on the first aggressor frequency during the first operating mode of the wireless communication device. A signal may be received, via the first receiver (e.g., a receiver of the transceiver 306 in FIG. 3), on the first victim frequency band during the first operating mode. Then, a self-jamming interference caused by the signal transmitted on the first aggressor frequency band interfering with the receiving signal on the first victim frequency band may be canceled using the shared NLIC module (e.g., the NLIC module 302 in FIG. 3) during the first operating mode of the wireless communication device.

Further, a signal may be received, via the second receiver (e.g., a receiver of the transceiver 304 in FIG. 3), on the second victim frequency band during the second operating mode of the wireless communication device. A signal may be transmitted, via the second transmitter (e.g., a transmitter of the transceiver 306 in FIG. 3), on the second aggressor frequency band during the second operating mode. Then, another self-jamming interference caused by the signal transmitted on the second aggressor frequency band interfering with the receiving signal on the second victim frequency band may be canceled using the shared NLIC module (e.g., the NLIC module 302 in FIG. 3) during the second operating mode of the wireless communication device.

According to aspects of the present disclosure, an apparatus for wireless communications is provided (e.g., the wireless communication device 300 from FIG. 3, the wireless communication device 400 from FIG. 4). The apparatus may comprise a plurality of transmitter-receiver pairs (e.g., the transceivers 304-306 from FIG. 3, the transceivers 404-408 from FIG. 4), and a shared non-linear interference cancellation (NLIC) module (e.g., the NLIC module 302 from FIG. 3, the NLIC module 402 from FIG. 4) configurable, in different operating modes of the apparatus involving different transmitter-receiver pairs, to cancel self-jamming interference caused by signals transmitted by one or more transmitters (e.g., a transmitter of the transceiver 304 from FIG. 3, transmitters of the transceivers 404-406 from FIG. 4) associated with a first set of the plurality of transmitter-receiver pairs on one or more aggressor frequency bands interfering with signals received by one or more receivers (e.g., a receiver of the transceiver 306 from FIG. 3, a receiver of the transceiver 408 from FIG. 4) associated with a second set of the plurality of transmitter-receiver pairs on one or more victim frequency bands.

According to aspects of the present disclosure, first radio access technologies (RATs) associated with the signals transmitted on the one or more aggressor frequency bands may be different from second RATs associated with the signals received on the one or more victim frequency bands. For example, the first RATs may comprise at least one of Wide Area Network (WAN) technology, Wireless Local Area Network (WLAN) technology, Global Positioning System (GPS) technology, or Bluetooth technology, and the second RATs may comprise at least one of Wide Area Network (WAN) technology, Wireless Local Area Network (WLAN) technology, Global Positioning System (GPS) technology, or Bluetooth technology.

According to aspects of the present disclosure, the plurality of transmitter-receiver pairs (e.g., the transceivers 304, 306 from FIG. 3) may comprise a first transceiver (e.g., the transceiver 304) and a second transceiver (e.g., the transceiver 306), the first transceiver may be configured, during a first of the operating modes, to transmit a signal on a first of the aggressor frequency bands, the second transceiver may be configured, during the first operating mode, to receive a signal on a first of the victim frequency bands, the shared NLIC module (e.g., the NLIC module 302 from FIG. 3) may be configured, during the first operating mode, to cancel a self-jamming interference caused by the signal transmitted on the first aggressor frequency band interfering with the received signal on the first victim frequency band to create an interference-mitigated signal and to provide the interference-mitigated signal to the second transceiver. According to aspects of the present disclosure, the first transceiver (e.g., the transceiver 304) may be further configured, during a second of the operating modes, to receive a signal on a second of the victim frequency bands, the second transceiver (e.g., the transceiver 306) may be further configured, during the second operating mode, to transmit a signal on a second of the aggressor frequency bands, and the shared NLIC module (e.g., the NLIC module 302) may be further configured, during the second operating mode, to cancel another self-jamming interference caused by the signal transmitted on the second aggressor frequency band interfering with the received signal on the second victim frequency band to create another interference-mitigated signal and to provide the interference-mitigated signal to the first transceiver.

According to aspects of the present disclosure, the second transceiver (e.g., the transceiver 306) may be further configured, during the first operating mode, to receive a composite signal comprising an intended signal received on the first victim frequency band and the self-jamming interference, and wherein the shared NLIC module (e.g., the NLIC module 302) may comprise: a first analog-to-digital converter (ADC) (e.g., the ADC 312 from FIG. 3) configured to perform analog-to-digital conversion of a baseband version of the signal transmitted on the first aggressor frequency band to generate a digitized aggressor signal, a second ADC (e.g., the ADC 314 from FIG. 3) configured to perform analog-to-digital conversion of the composite intended signal plus self-jamming interference to generate a digital composite signal, an adaptive NLIC filter (e.g., the NLIC filter 318 from FIG. 3) configured to process the digitized aggressor signal to generate an estimated interference signal, a circuit (e.g., an arithmetic unit 324 from FIG. 3) configured to subtract the estimated interference signal from the digital composite intended signal plus self-jamming interference to remove the self-jamming interference, and a digital-to-analog converter (DAC) (e.g., the DAC 316 from FIG. 3) configured to perform digital-to-analog conversion of the digital composite signal without the self-jamming interference as it was removed in the arithmetic unit 324.

According to aspects of the present disclosure, the first transceiver (e.g., the transceiver 304) may be further configured, during the second operating mode, to receive another composite signal comprising the received signal on the second victim frequency band and the other self-jamming interference, the first ADC (e.g., the ADC 312) may be further configured to perform analog-to-digital conversion of a baseband version of the signal transmitted on the second aggressor frequency band to generate another digitized aggressor signal, the second ADC (e.g., the ADC 314) may be further configured to perform analog-to-digital conversion of the other composite intended signal plus self-jamming interference to generate another digital composite signal, the adaptive NLIC filter (e.g., the NLIC filter 318) may be further configured to process the other digitized aggressor signal to generate another estimated interference signal, the circuit (e.g., the arithmetic unit 324) may be further configured to subtract the other estimated interference signal from the other digital composite signal to remove the other self-jamming interference, and the DAC (e.g., the DAC 316) may be further configured to perform digital-to-analog conversion of the other digital composite signal without the other self-jamming interference as it was removed in the arithmetic unit 324.

According to aspects of the present disclosure, the apparatus (e.g., the wireless communication device 300 from FIG. 3) may further comprise a first interfacing circuit (e.g., a multiplexer 326 from FIG. 3) configured to interface the baseband version of the signal transmitted on the first aggressor frequency band with the first ADC (e.g., the ADC 312) during the first operating mode, and to interface the baseband version of the signal transmitted on the second aggressor frequency band with the first ADC (e.g., the ADC 312) during the second operating mode, a second interfacing circuit (e.g., a multiplexer 328 from FIG. 3) configured to interface the composite signal with the second ADC (e.g., the ADC 314) during the first operating mode, and to interface the other composite signal with the second ADC (e.g., the ADC 314) during the second operating mode, and a third interfacing circuit (e.g., a de-multiplexer 330 from FIG. 3) configured to interface the DAC (e.g., the DAC 316) with the second transceiver (e.g., the transceiver 306) during the first operating mode, and to interface the DAC (e.g., the DAC 316) with the first transceiver (e.g., the transceiver 304) during the second operating mode.

According to aspects of the present disclosure, the first ADC (e.g., the ADC 312), the second ADC (e.g., the ADC 314), and the DAC (e.g., the DAC 316) may operate utilizing a common reference clock signal (e.g., the clock signal 317 illustrated in FIG. 3). The apparatus (e.g., the wireless communication device 300) may further comprise a controller (e.g., the controller 310 from FIG. 3) configured to program the adaptive NLIC filter (e.g., the NLIC filter 318) according to a non-linear self-jamming mechanism. In an aspect of the present disclosure, the non-linear self-jamming mechanism may depend, during the first operating mode, on the first aggressor frequency band and the first victim frequency band. In another aspect, during the second operating mode, the non-linear self-jamming mechanism may depend on the second aggressor frequency band and the second victim frequency band.

According to aspects of the present disclosure, the apparatus (e.g., the wireless communication device 300) may further comprise a controller (e.g., the controller 310) configured to: program a sampling rate for the one or more of the first and second ADCs (e.g., the ADCs 312, 314) based on a bandwidth associated with the first aggressor frequency band and the first victim frequency band during the first operating mode, and program a sampling rate for the one or more of the first and second ADCs (e.g., the ADCs 312, 314) based on a bandwidth associated with the second aggressor frequency band and the second victim frequency band during the second operating mode.

The various operations of methods described above may be performed by any suitable means capable of performing the corresponding functions. The means may include various hardware and/or software component(s) and/or module(s), including, but not limited to a circuit, an application specific integrated circuit (ASIC), or processor, such as the processor 230 of the transmitter system 210 and/or the processor 270 of the receiver system 250 illustrated in FIG. 2. Generally, where there are operations illustrated in figures, those operations may have corresponding counterpart means-plus-function components with similar numbering. For example, operations 500 illustrated in FIG. 5 correspond to means 500A illustrated in FIG. 5A.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. An apparatus for wireless communications, comprising:
a plurality of transmitter-receiver pairs; and
a shared non-linear interference cancellation (NLIC) module configurable, in different operating modes of the apparatus involving different transmitter-receiver pairs, to cancel self-jamming interference caused by signals transmitted by one or more transmitters associated with a first set of the plurality of transmitter-receiver pairs on one or more aggressor frequency bands interfering with signals received by one or more receivers associated with a second set of the plurality of transmitter-receiver pairs on one or more victim frequency bands.

2. The apparatus of claim 1, wherein:
first radio access technologies (RATs) associated with the signals transmitted on the one or more aggressor frequency bands are different from second RATs associated with the signals received on the one or more victim frequency bands.

3. The apparatus of claim 2, wherein:
the first RATs comprise at least one of Wide Area Network (WAN) technology, Wireless Local Area Network (WLAN) technology, Global Positioning System (GPS) technology, or Bluetooth technology, and
the second RATs comprise at least one of Wide Area Network (WAN) technology, Wireless Local Area Network (WLAN) technology, Global Positioning System (GPS) technology, or Bluetooth technology.

4. The apparatus of claim 1, wherein:
the plurality of transmitter-receiver pairs comprise a first transceiver and a second transceiver;
the first transceiver is configured, during a first of the operating modes, to transmit a signal on a first of the aggressor frequency bands;
the second transceiver is configured, during the first operating mode, to receive a signal on a first of the victim frequency bands;
the shared NLIC module is configured, during the first operating mode, to cancel a self-jamming interference caused by the signal transmitted on the first aggressor frequency band interfering with the received signal on the first victim frequency band to create an interference-mitigated signal and to provide the interference-mitigated signal to the second transceiver;
the first transceiver is further configured, during a second of the operating modes, to receive a signal on a second of the victim frequency bands;
the second transceiver is further configured, during the second operating mode, to transmit a signal on a second of the aggressor frequency bands; and
the shared NLIC module is further configured, during the second operating mode, to cancel another self-jamming interference caused by the signal transmitted on the second aggressor frequency band interfering with the received signal on the second victim frequency band to create another interference-mitigated signal and to provide the interference-mitigated signal to the first transceiver.

5. The apparatus of claim 4, wherein
the second transceiver is further configured, during the first operating mode, to receive a composite signal comprising an intended signal received on the first victim frequency band and the self-jamming interference, and wherein the shared NLIC module comprises:
a first analog-to-digital converter (ADC) configured to perform analog-to-digital conversion of a baseband version of the signal transmitted on the first aggressor frequency band to generate a digitized aggressor signal,
a second ADC configured to perform analog-to-digital conversion of the composite signal to generate a digital composite signal,
an adaptive NLIC filter configured to process the digitized aggressor signal to generate an estimated interference signal,
a circuit configured to subtract the estimated interference signal from the digital composite signal to remove the self-jamming interference, and
a digital-to-analog converter (DAC) configured to perform digital-to-analog conversion of the digital composite signal without the self-jamming interference.

6. The apparatus of claim 5, wherein:
the first transceiver is further configured, during the second operating mode, to receive another composite signal comprising the received signal on the second victim frequency band and the other self-jamming interference,
the first ADC is further configured to perform analog-to-digital conversion of a baseband version of the signal transmitted on the second aggressor frequency band to generate another digitized aggressor signal,
the second ADC is further configured to perform analog-to-digital conversion of the other composite signal to generate another digital composite signal,
the adaptive NLIC filter is further configured to process the other digitized aggressor signal to generate another estimated interference signal,
the circuit is further configured to subtract the other estimated interference signal from the other digital composite signal to remove the other self-jamming interference, and
the DAC is further configured to perform digital-to-analog conversion of the other digital composite signal without the other self-jamming interference.

7. The apparatus of claim 6, further comprising:
a first interfacing circuit configured to interface the baseband version of the signal transmitted on the first aggressor frequency band with the first ADC during the first operating mode, and to interface the baseband version of the signal transmitted on the second aggressor frequency band with the first ADC during the second operating mode;
a second interfacing circuit configured to interface the composite signal with the second ADC during the first operating mode, and to interface the other composite signal with the second ADC during the second operating mode; and
a third interfacing circuit configured to interface the DAC with the second transceiver during the first operating mode, and to interface the DAC with the first transceiver during the second operating mode.

8. The apparatus of claim 5, wherein the first ADC, the second ADC, and the DAC operate using a common reference clock signal.

9. The apparatus of claim 5, further comprising:
a controller configured to program the adaptive NLIC filter according to a non-linear self-jamming mechanism, wherein
the non-linear self-jamming mechanism depends, during the first operating mode, on the first aggressor frequency band and the first victim frequency band, and
the non-linear self-jamming mechanism depends, during the second operating mode, on the second aggressor frequency band and the second victim frequency band.

10. The apparatus of claim 5, further comprising:
a controller configured to:
program a sampling rate for one or more of the first and second ADCs based on a bandwidth associated with the first aggressor frequency band and the first victim frequency band during the first operating mode; and
program a sampling rate for one or more of the first and second ADCs based on a bandwidth associated with the second aggressor frequency band and the second victim frequency band during the second operating mode.

11. A method for wireless communications, comprising:
configuring a shared non-linear interference cancellation (NLIC) module, in a first operating mode involving a first transmitter-receiver pair of a plurality of transmitter-receiver pairings, to cancel self-jamming interference caused by signals transmitted by a first transmitter on a first aggressor frequency band interfering with signals received by a first receiver on a first victim frequency band; and
configuring the shared NLIC module, in a second operating mode involving a second transmitter-receiver pair, to cancel self-jamming interference caused by signals transmitted by a second transmitter on a second aggressor frequency band interfering with signals received by a second receiver on a second victim frequency band.

12. The method of claim 11, wherein:
first radio access technologies (RATs) associated with the signals transmitted on the one or more aggressor frequency bands are different from second RATs associated with the signals received on the one or more victim frequency bands.

13. The method of claim 12, wherein:
the first RATs comprise at least one of Wide Area Network (WAN) technology, Wireless Local Area Network (WLAN) technology, Global Positioning System (GPS) technology, or Bluetooth technology, and
the second RATs comprise at least one of Wide Area Network (WAN) technology, Wireless Local Area Network (WLAN) technology, Global Positioning System (GPS) technology, or Bluetooth technology.

14. The method of claim 11, wherein
the plurality of transmitter-receiver pairs comprise a first transceiver and a second transceiver, and the method further comprising:
transmitting, via the first transceiver during a first of the operating modes, a signal on a first of the aggressor frequency bands;
receiving, via the second transceiver during the first operating mode, a signal on a first of the victim frequency bands;
canceling, by the shared NLIC module during the first operating mode, a self-jamming interference caused by the signal transmitted on the first aggressor frequency band interfering with the received signal on the first victim frequency band to create an interference-mitigated signal and to provide the interference-mitigated signal to the second transceiver;
receiving, via the first transceiver during a second of the operating modes, a signal on a second of the victim frequency bands;
transmitting, via the second transceiver during the second operating mode, a signal on a second of the aggressor frequency bands; and
canceling, by the shared NLIC module during the second operating mode, another self-jamming interference caused by the signal transmitted on the second aggressor frequency band interfering with the received signal on the second victim frequency band to create another interference-mitigated signal and to provide the interference-mitigated signal to the first transceiver.

15. The method of claim 14, wherein the shared NLIC module comprises a first analog-to-digital converter (ADC), a second ADC, an adaptive NLIC filter, and a digital-to-analog converter (DAC), and the method further comprising:
receiving, via the second transceiver during the first operating mode, a composite signal comprising an intended signal received on the first victim frequency band and the self-jamming interference;
performing, by the first ADC, analog-to-digital conversion of a baseband version of the signal transmitted on the first aggressor frequency band to generate a digitized aggressor signal;
performing, by the second ADC, analog-to-digital conversion of the composite signal to generate a digital composite signal;
processing, by the adaptive NLIC filter, the digitized aggressor signal to generate an estimated interference signal;
subtracting the estimated interference signal from the digital composite signal to remove the self-jamming interference; and
performing, by the DAC, digital-to-analog conversion of the digital composite signal without the self-jamming interference.

16. The method of claim 15, further comprising:
receiving, via the first transceiver during the second operating mode, another composite signal comprising the received signal on the second victim frequency band and the other self-jamming interference;
performing, by the first ADC, analog-to-digital conversion of a baseband version of the signal transmitted on the second aggressor frequency band to generate another digitized aggressor signal;
performing, by the second ADC, analog-to-digital conversion of the other composite signal to generate another digital composite signal;
processing, by the adaptive NLIC filter, the other digitized aggressor signal to generate another estimated interference signal;
subtracting the other estimated interference signal from the other digital composite signal to remove the other self-jamming interference; and
performing, by the DAC, digital-to-analog conversion of the other digital composite signal without the other self-jamming interference.

17. The method of claim 16, further comprising:
interfacing the baseband version of the signal transmitted on the first aggressor frequency band with the first ADC during the first operating mode;
interfacing the baseband version of the signal transmitted on the second aggressor frequency band with the first ADC during the second operating mode;
interfacing the composite signal with the second ADC during the first operating mode;
interfacing the other composite signal with the second ADC during the second operating mode;
interfacing the DAC with the second transceiver during the first operating mode; and
interfacing the DAC with the first transceiver during the second operating mode.

18. The method of claim 15, further comprising:
operating the first ADC, the second ADC, and the DAC using a common reference clock signal.

19. The method of claim 15, further comprising:
programming the adaptive NLIC filter according to a non-linear self-jamming mechanism, wherein
the non-linear self-jamming mechanism depends, during the first operating mode, on the first aggressor frequency band and the first victim frequency band, and
the non-linear self-jamming mechanism depends, during the second operating mode, on the second aggressor frequency band and the second victim frequency band.

20. The method of claim 15, further comprising:
programming a sampling rate for one or more of the first and second ADCs based on a bandwidth associated with the first aggressor frequency band and the first victim frequency band during the first operating mode; and
programming a sampling rate for one or more of the first and second ADCs based on a bandwidth associated with the second aggressor frequency band and the second victim frequency band during the second operating mode.

21. An apparatus for wireless communications, comprising:
means for configuring a shared non-linear interference cancellation (NLIC) module, in a first operating mode involving a first transmitter-receiver pair, to cancel self-jamming interference caused by signals transmitted by a first transmitter on a first aggressor frequency band interfering with signals received by a first receiver on a first victim frequency band; and
means for configuring the shared NLIC module, in a second operating mode involving a second transmitter-receiver pair, to cancel self-jamming interference caused by signals transmitted by a second transmitter on a second aggressor frequency band interfering with signals received by a second receiver on a second victim frequency band.

22. The apparatus of claim 21, wherein:
first radio access technologies (RATs) associated with the signals transmitted on the one or more aggressor frequency bands are different from second RATs associated with the signals received on the one or more victim frequency bands.

23. The apparatus of claim 21, further comprising:
means for transmitting, during a first of the operating modes, a signal on a first of the aggressor frequency bands;
means for receiving, during the first operating mode, a signal on a first of the victim frequency bands;
means for canceling, during the first operating mode, a self-jamming interference caused by the signal transmitted on the first aggressor frequency band interfering with the received signal on the first victim frequency band to create an interference-mitigated signal and to provide the interference-mitigated signal to the second transceiver;
means for receiving, during a second of the operating modes, a signal on a second of the victim frequency bands;
means for transmitting, during the second operating mode, a signal on a second of the aggressor frequency bands; and
means for canceling, during the second operating mode, another self-jamming interference caused by the signal transmitted on the second aggressor frequency band interfering with the received signal on the second victim frequency band to create another interference-mitigated signal and to provide the interference-mitigated signal to the first transceiver.

24. The apparatus of claim 23, further comprising:
means for receiving, during the first operating mode, a composite signal comprising an intended signal received on the first victim frequency band and the self-jamming interference;
means for performing analog-to-digital conversion of a baseband version of the signal transmitted on the first aggressor frequency band to generate a digitized aggressor signal;
means for performing analog-to-digital conversion of the composite signal to generate a digital composite signal;
means for processing the digitized aggressor signal to generate an estimated interference signal;
means for subtracting the estimated interference signal from the digital composite signal to remove the self-jamming interference; and
means for performing digital-to-analog conversion of the digital composite signal without the self-jamming interference.

25. The apparatus of claim 24, further comprising:
means for receiving, during the second operating mode, another composite signal comprising the received signal on the second victim frequency band and the other self-jamming interference;
means for performing analog-to-digital conversion of a baseband version of the signal transmitted on the second aggressor frequency band to generate another digitized aggressor signal;
means for performing analog-to-digital conversion of the other composite signal to generate another digital composite signal;
means for processing the other digitized aggressor signal to generate another estimated interference signal;
means for subtracting the other estimated interference signal from the other digital composite signal to remove the other self-jamming interference; and
means for performing digital-to-analog conversion of the other digital composite signal without the other self-jamming interference.

26. The apparatus of claim 25, further comprising:
means for interfacing the baseband version of the signal transmitted on the first aggressor frequency band with the first ADC during the first operating mode;
means for interfacing the baseband version of the signal transmitted on the second aggressor frequency band with the first ADC during the second operating mode;
means for interfacing the composite signal with the second ADC during the first operating mode;
means for interfacing the other composite signal with the second ADC during the second operating mode;
means for interfacing the DAC with the second transceiver during the first operating mode; and
means for interfacing the DAC with the first transceiver during the second operating mode.

27. The apparatus of claim 21, further comprising:
means for operating components of the apparatus using a common reference clock signal.

28. A computer-readable medium having instructions executable by a computer stored thereon for:
configuring a shared non-linear interference cancellation (NLIC) module, in a first operating mode involving a first transmitter-receiver pair, to cancel self-jamming interference caused by signals transmitted by a first transmitter on a first aggressor frequency band interfering with signals received by a first receiver on a first victim frequency band; and
configuring the shared NLIC module, in a second operating mode involving a second transmitter-receiver pair, to cancel self-jamming interference caused by signals transmitted by a second transmitter on a second aggressor frequency band interfering with signals received by a second receiver on a second victim frequency band.

29. The computer-readable medium of claim 28, wherein one or more components of the NLIC module operate using a common reference clock signal.
